(19) United States
(12) Patent Application Publication
(10) Pub. No.: US 2005/0129913 A1
(43) Pub. Date: Jun. 16, 2005

(54) Building material and method of manufacturing the material

(75) Inventors: Hideki Kobayashi, Fukuoka (JP); Tatsushi Nagae, Fukuoka (JP)

Correspondence Address: BIRCH STEWART KOLASCH & BIRCH, PO BOX 747, FALLS CHURCH, VA, 22040-0747, US

(73) Assignee: TOTO LTD., Fukuoka (JP)

(21) Appl. No.: 10/502,780

(22) PCT Filed: Jan. 28, 2003
(86) PCT No.: PCT/JP03/00793

(30) Foreign Application Priority Data
Jan. 28, 2002 (JP) 2002-18282

(51) Int. Cl. B32B 3/28

(52) U.S. Cl. 428/167; 428/156

(57) ABSTRACT

The present invention provides a building material in which water remaining on the surface can be dried up quickly and keep a hygienic state for a long period of time. The building material is comprised of grooves having a width of 0.5 mm or more and 3.0 mm or less and a depth of 0.5 mm or more and 2.0 mm or less, the grooves being arranged in multiple directions, and island-shaped projections for preventing slippage constructed of a unit having a size of 5 mm×5 mm or more and 25 mm×25 mm or less, the island-shaped projections being surrounded by the grooves, wherein the surface of the island-shaped projections for preventing slippage has a flat shape or a curved shape.

### TECHNICAL FIELD

The present invention relates to a building material suitable for a floor material of a bathroom, a food factory, a pool, a public toilet or the like, which needs to prevent slipping because water easily collects thereon.

### BACKGROUND ART

In a food factory, for example, cleaning with water or hot water is conducted when work operations are finished for the purpose of keeping hygiene. However, in a case of a floor coated by an epoxy resin, water remains and collects after the cleaning, and is not dried until the following day, which may cause workers to slip. Also, since the remaining water tends to stay in the same place so as to become the ideal place for fungi or mold, it is not preferable from the viewpoint of hygiene.

In a pool, water collects on a pool deck. Also, in a public toilet, for example, at highway rest stops, slipping easily occurs at the time of cleaning. This is because water used for cleaning collects on a building material so as to produce large waterdrops, or the wet state lasts for a long period of time. No building material has been developed in which drying is promoted and waterdrops are prevented from bring generated so as to solve the problem.

As a method for solving the conventional problem, a method has been known in which waterdrops remaining on the surface are reduced and drying is promoted by making the floor surface hydrophilic. However, even if the surface is made hydrophilic, organic materials or other contaminants adhere to the surface in actual conditions of use, and the hydrophilic effect is lost by oil included in the contaminants, so as to cause waterdrops to be left.

The present invention has been achieved to solve the above-mentioned problem, and the object of the present invention is to provide a building material in which water remaining on the surface of the building material is quickly dried and the hygienic state is maintained for a long period of time.

### DISCLOSURE OF THE INVENTION

In order to solve the above-mentioned problem, a building material according to the present invention is comprised of grooves having a width of 0.5 mm or more and 3.0 mm or less and a depth of 0.5 mm or more and 2.0 mm or less, the grooves being arranged in multiple directions, and island-shaped projections for preventing slippage constructed of a unit having a size of 5 mm×5 mm or more and 25 mm×25 mm or less, the island-shaped projections being surrounded by the grooves, wherein the surface of the island-shaped projections for preventing slippage has a flat shape or a curved shape.

With this structure, it is possible to provide a building material in which water remaining on the surface can be dried up quickly and keep a hygienic state for a long period of time. Hereinafter, the reason for this is described in detail.

The width and the depth of the grooves are arranged and the direction of the grooves are made multiple, such that water easily flows toward the grooves without remaining on the projections and water flows slowly in the grooves when the surface is cleaned with water. Also, by providing the island-shaped projections for preventing slippage, it is possible to make the waterdrops remaining on the surface small. In addition, in order to prevent a user from feeling pain when the user's bare feet touch the floor, the surface of the island-shaped projections for preventing slippage is made flat or curved.

With this arrangement of the grooves, the water used for cleaning flows slowly in the grooves, and finally leads to a drain groove. Also, with the provision of the island-shaped projections, it is possible to prevent shoes or bare feet from coming into contact with the bottom of the grooves. Consequently, the grooves surely serve as a drain passage even in a wet state. In addition, since water is surely drained from the grooves, a thin water film can be prevented from being generated between shoes or bare feet and the floor building material, and slippage can be prevented effectively.

In the present invention, a width of the grooves on the surface of the building material is 0.5 mm or more and 3.0 mm or less, and a depth thereof is 0.5 mm or more and 2.0 mm or less. If the width is less than 0.5 mm and the depth exceeds 2.0 mm, it is extremely difficult to produce such grooves on the surface of the building material. If the width exceeds 3.0 mm and the depth is less than 0.5 mm, there is a strong likelihood that shoes or bare feet come into contact with the bottom of the grooves. In a case where they come into contact with the bottom of the grooves, the flow passage of water is blocked and slippage unpreferably occurs.

The grooves are arranged in multiple directions, which means that the grooves are not in a single direction. If the grooves are in a single direction, the flow of water is made smooth, the water is sent to the drain groove quickly, and thereby it becomes difficult to make the water collect in the grooves. On the other hand, when the direction of the grooves is varied to be multiple, the flow of water becomes unstable, the water collects in the grooves, and thereby the flow velocity is reduced. In this instance, since the water collects in the flow passage, the water on the projections is lead in the direction of the flow passage, and thereby the water can be prevented from remaining on the surface of the projections.

The island-shaped projections for preventing slippage are constructed of a unit having a size of 5 mm×5 mm or more and 25 mm×25 mm or less. If the size of a unit is less than 5 mm×5 mm, the area thereof becomes similar to that of the grooves, and the possibility that shoes or bare feet will come into contact with the bottom of the grooves becomes high. If they come into contact with the bottom of the grooves, the flow passage of water is blocked and slippage unpreferably occurs. Also, from the data which has been compiled, in order to completely air-dry waterdrops in 8 hours which can remain independently, the limit of the amount of the waterdrops is about 2 cc at temperature of 15° C. and humidity of 70%. The contact angle of the waterdrops of 2 cc with respect to the building material is generally 30-60°, and this value is much smaller in a case of a hydrophilic material. If the contact angle after metallic soap adheres by daily use is assumed to be 60°, the diameter of the waterdrops formed by water of 2 cc on the floor material is about 25 mm. Therefore, the size of the island-shaped projections is preferably 25 mm×25 mm or less.

The surface of the island-shaped projections for preventing slippage is made flat or curved. By doing so, it is possible to prevent a user from feeling pain when the user's bare feet touch the floor.

In addition, the shape of a single piece of building material in which a plurality of grooves and a plurality of island-shaped projections for preventing slippage are provided on the surface may be a shape having a higher central portion and a lower peripheral portion, and the shape can be used as a single one or a combination thereof. The example of the combination includes a case where the central portion is a dome shape and the outside thereof is a stairs shape. With such a shape, water can smoothly flow into the joint between the pieces of building material.

In a preferred embodiment of the present invention, the grooves are made not to absorb water substantially. By doing so, the grooves can be prevented from being in a water-keeping state and becoming the ideal place for fungi or mold, so as to achieve a more preferable state from the viewpoint of hygiene.

In another preferred embodiment of the present invention, the grooves include an anti-bacterial agent. By doing so, the grooves can be prevented from being in a water-keeping state and becoming the ideal place for fungi or mold, so as to achieve a more preferable state from the viewpoint of hygiene.

In a preferred embodiment of the present invention, the size of the building material is 100 mm×100 mm or more and 900 mm×1800 mm or less.

If the size is less than 100 mm×100 mm, the construction efficiency is poor. On the other hand, if it is more than 900 mm×1800 mm, the building material needs careful handling, or needs to be cut at the time of the construction.

In a preferred embodiment of the present invention, the shape of the grooves may be any of a trapezoid shape, a semicircular shape, a U shape, and a V shape. However, it is preferable that the shape of the grooves is one in which the area of the upper portion is greater than that of the lower potion. With such a shape, it becomes easy to clean the grooves.

In a preferred embodiment of the present invention, the building material in which water is quickly dried is an inorganic ceramic material such as tile, a pottery plate or glass, an organic material whose surface is coated with an inorganic material, or an organic-inorganic composite material including an inorganic filler, which is comprised of an oxide or a composite oxide, at a ratio of 50% or more.

Hardly any waterdrops remain on an inorganic material because its contact angle with respect to water is smaller than that of another material. Therefore, even in a case of an organic material, by coating the surface of the organic material with an inorganic material or by mixing inorganic silica particles into the organic material, it is possible to achieve a much higher hydrophilic property compared with a base comprised of an organic material alone, and impart a property of preventing water from remaining on the surface.

As the inorganic material with which the surface can be coated, it is preferable to use SiO₂, Al₂O₃, ZrO₂, Fe₂O₃, CaO, MgO, K₂O, Na₂O, a material having a photocatalytic function such as TiO₂, ZnO, SnO₂ or the like, a material having an anti-bacterial property such as Ag, Cu or the like, or a composite material thereof. It is more preferable to use the above-mentioned materials in a state of concentrating in the grooves. Among the above-mentioned materials, the material having a photocatalytic function such as TiO₂, ZnO, SnO₂ or the like, the material having an anti-bacterial property such as Ag, Cu or the like, or the composite material thereof are more preferable because they can support a hydrophilic property of the surface by the photocatalytic effect, or impart an anti-bacterial property.

As the inorganic filler which is added to the organic material, it is preferable to use SiO₂, Al₂O₃, ZrO₂, Fe₂O₃, CaO, MgO, K₂O, Na₂O, a material having a photocatalytic function such as TiO₂, ZnO, SnO₂ or the like, a material having an anti-bacterial property such as Ag, Cu or the like, or a composite material thereof. Among the above-mentioned materials, the material having a photocatalytic function such as TiO₂, ZnO, SnO₂ or the like, the material having an anti-bacterial property such as Ag, Cu or the like, or the composite material thereof are more preferable because they can support a hydrophilic property of the surface by the photocatalytic effect, or impart an anti-bacterial property.

In a preferred embodiment of the present invention, it is possible to employ a method for manufacturing a common tile as the method for manufacturing the building material according to the present invention.

According to a pressure forming method, a projection is provided on the side of a die which becomes a surface of a tile so as to form a groove in the tile. By conducting pressure forming with this die, it is possible to obtain a tile having a groove on the surface thereof. A glaze is applied on the tile if needed, and fired so as to obtain a desired building material.

It is also possible to produce a groove later by irradiating a flat plate, which is obtained by pressure forming, with laser light having a small intensity in a pattern-like manner. As a method for forming a groove later, it is also possible to employ a method in which a groove is directly dug with a grindstone, or a method which uses sandblasting.

In a preferred embodiment of the present invention, it is also possible to employ a manufacturing method in which a concavo-convex die having a pattern on the surface thereof is pushed onto a tile body formed in a flat-plate like by extrusion. It is also possible to employ a method in which a roller or a plate having a groove pattern is pushed onto a tile body which is extruded in a flat-plate like so as to form a groove in the body of a soft state. The body having a groove formed is dried, a glaze is applied if needed, and firing is conducted, so as to obtain a desired building material.

In a preferred embodiment of the present invention, it is also possible to employ a method in which injection molding is conducted by using a mold having a groove. This method can be applied especially to a resin product.

In a preferred embodiment of the present invention, it is effective to coat a surface of the projections, which are formed as a result of forming grooves in the building material, with a water-repellent material. The hydrophilic grooves and the water-repellent surface allow water on the surface to quickly gather in the groove, so as to accelerate drying of the floor and draining of the water. As the water-repellent material, a silicone-based material is easy to use. However, a fluorine-based material may also be used.

### BRIEF DESCRIPTION OF THE DRAWINGS

FIG. 1 is a plan view of a building material according to the present invention;

FIG. 2 is an enlarged plan view of the building material;

FIG. 3 is an enlarged perspective view of the building material before water is fed;

FIG. 4 is an enlarged perspective view of the building material after water is fed;

FIG. 5 is a view showing an embodiment of the building material according to the present invention;

FIG. 6 is a view showing another embodiment of the building material according to the present invention;

FIG. 7 is a view showing another embodiment of the building material according to the present invention;

FIGS. 8(a)-(c) are a view showing another embodiment of the building material according to the present invention; and

FIGS. 9(a)-(c) are a view showing another embodiment of the building material according to the present invention.

### BEST MODE FOR CARRYING OUT THE INVENTION

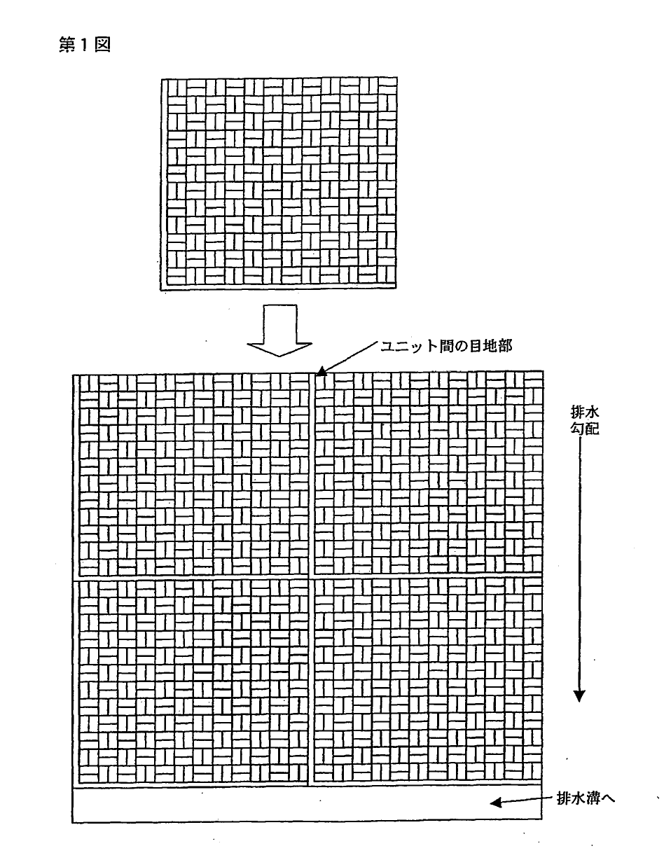

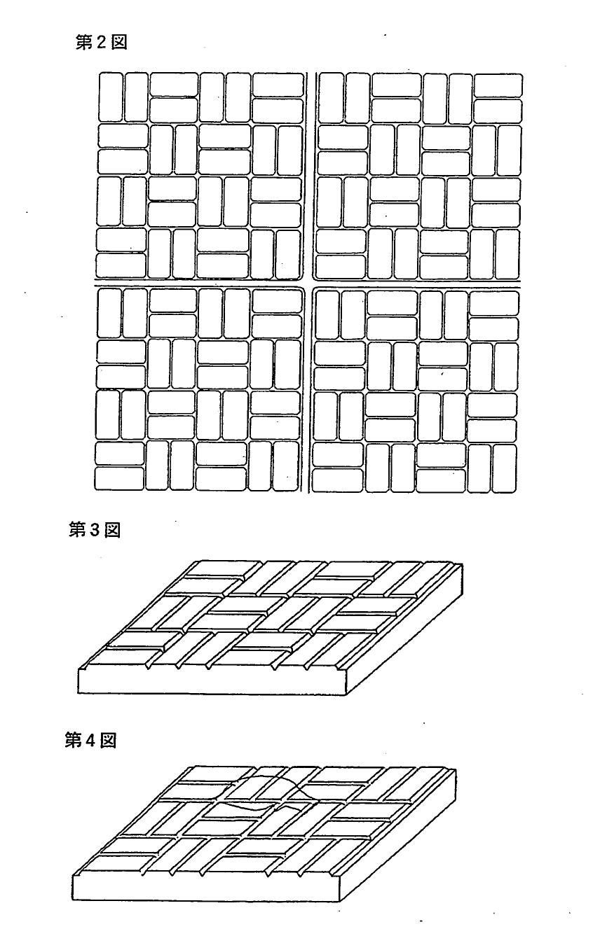

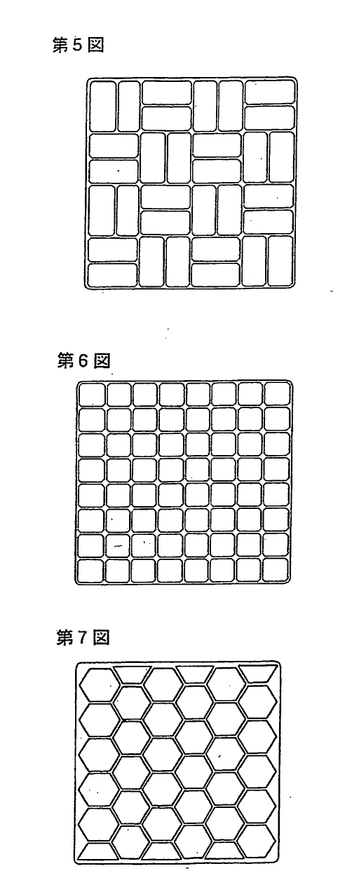

Detailed explanations will now be described with regard to the building material in which drying of water on the surface is promoted according to the present invention. FIG. 1 is a plan view of the building material according to the present invention, FIG. 2 is an enlarged plan view thereof, FIGS. 3 and 4 are an enlarged perspective view of the building material before and after water is fed, and FIGS. 5-7 shows various kinds of patterns.

As shown in FIG. 1, the building material is arranged such that a gradient is provided toward a drain groove so as to drain water. Water flows on the building material along the drain gradient and gathers in the drain groove. A joint is provided at each unit of the building material, and water can also flow along the gradient through the joints.

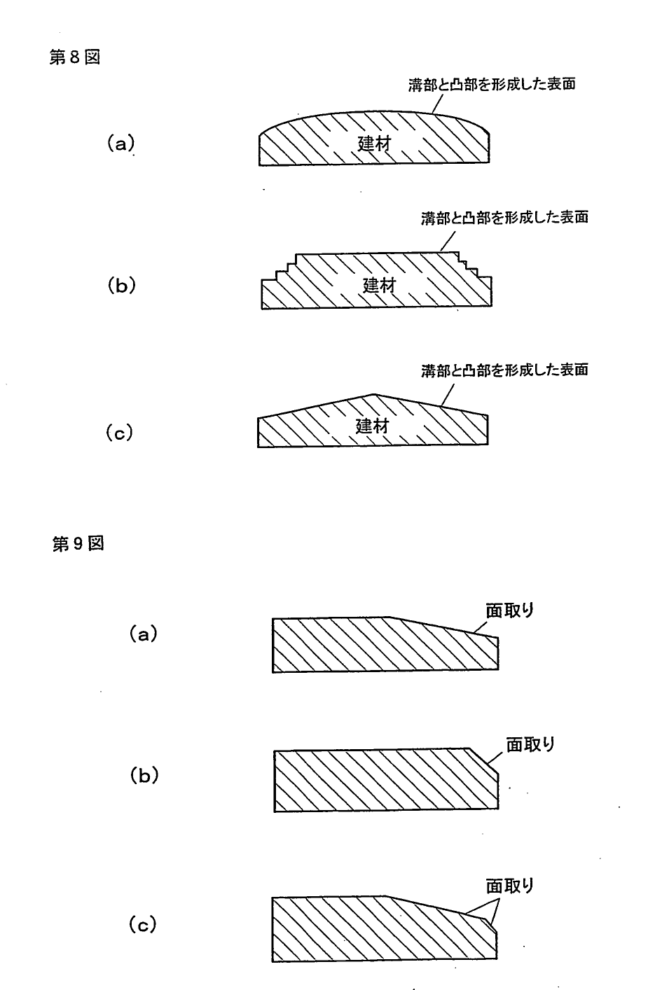

A pattern of the shape is not limited to a particular one unless water remains on island-shaped projections. Various patterns may be employed, and the example includes a square as shown in FIG. 6, a hexagon as shown in FIG. 7, a trapezoid, a rhombus, a circle, an ellipse, and a triangle as well as a rectangle as shown in FIG. 5.

With regard to the cross-sectional shape of the building material, the center portion is high, and an incline is provided toward the peripheral portion. The specific example includes a dome shape as shown in FIG. 8(a), a stairs shape as shown in FIG. 8(b), and a taper shape as shown in FIG. 8(c). Also, chamfering may be conducted to the end of the building material as shown in FIGS. 9(a)-(c).

As shown in FIGS. 2 and 3, grooves are formed on the surface of the building material. As a method for forming the groove, various methods can be used such as pressure forming, a method in which a groove is dug in a raw body obtained by pressure forming, a method in which extrusion forming is conducted in a plastic state and a groove is formed by pushing a die, injection molding, or casting. In order to facilitate drawing from the die, the shape of the groove is one in which the area of the upper portion is greater than that of the lower potion when it is seen from above.

In a case where the formed material is ceramics such as file, it is possible to apply a glaze to the surface thereof depending on the necessity. In this instance, if the thickness of the glaze layer is large, the glaze might enter the formed grooves, and fill the grooves after being fired. Therefore, the thickness of the glaze layer should be 0.4 mm or less.

For the building material, an inorganic material such as tile, a pottery plate, glass, cement or the like can be used as a preferable one. Incidentally, both cases where a glaze is applied and no glaze is applied are possible with regard to tile and a pottery plate.

As an organic material which is coated with an inorganic material, various kinds such as FRP, acrylic, vinyl chloride, phenol resin can be used.

As an inorganic filler which constitutes a composite with an organic material, it is possible to use SiO₂, Al₂O₃, ZrO₂, Fe₂O₃, CaO, MgO, K₂O, Na₂O, a material having a photocatalytic function such as TiO₂, ZnO, SnO₂ or the like, a material having an anti-bacterial property such as Ag, Cu or the like, or a composite material thereof. In any case, it is preferable that the material is in a powder state, and the shape may be a sphere shape, a needle shape, a column shape, and a cube shape, or a chain shape.

If painting is conducted to the ceramics by using a transfer paper, a mount is separated by adding water thereto, the transfer paper from which the mount is separated is attached to the surface of the ceramics, dried, and cured in an atmosphere of 150-250° C. By doing so, the ceramics can have a desired painting.

### EXAMPLE 1-1

An earthenware tile on which a glaze was applied and having a size of 300 mm×300 mm was produced, in which each unit had a square shape of 20 mm×20 mm, and grooves having a V shape, a width of 2 mm and a depth of 1 mm were formed. As the method for producing thereof, pressure forming was employed. Specifically, by using a die in which projections were provided so as to form desired grooves in a formed product, pressure was applied so as to obtain a formed product, the product was biscuit-fired, a glaze was applied thereto, and it was fired at a temperature of 1200° C. for 40 minutes. The tile was arranged on a floor at a tilt angle of around 5 degrees, and water was fed to the surface of the tile. The water dispersed on the fresh glaze of the tile (a fresh one has a high hydrophilic property and its contact angle with respect to water is about 20 degrees), and flowed along the grooves. Although some water remained on the island-shaped projections like a thin film, the water was air-dried after an hour. This was exposed on the floor of a bathroom for a month. Metallic soap adhered to the island-shaped projections, and the hydrophilic property was impaired. The contact angle with respect to water became around 60 degrees. When water was fed to the tile again in the same manner as at the time of being new, the water collected in the grooves, and waterdrops on the surface were gradually absorbed into the water in the grooves. Finally, no water was left on the island-shaped projections. Also, the surface was air-dried for eight hours, and it was confirmed that the entire surface was almost dried up.

### EXAMPLE 1-2

A stoneware tile on which a glaze was applied and having a size of 300 mm×300 mm was produced, in which each unit had a square shape of 20 mm×20 mm, and grooves having a V shape, a width of 2 mm and a depth of 1 mm were formed. As the method for producing thereof, wet extrusion forming was employed. Specifically, a tile raw body was formed into a plate shape by extrusion forming, and a metal roller having a pattern for forming grooves was pushed thereonto. The product was dried and biscuit-fired, a glaze was applied thereto, and it was fired at a temperature of 1200° C. for 60 minutes. The tile was arranged on a floor at a tilt angle of around 5 degrees, and water was fed to the surface of the tile. The water dispersed on the fresh glaze of the tile (a fresh one has a high hydrophilic property and its contact angle with respect to water is about 20 degrees), and flowed along the grooves. Although some water remained on the island-shaped projections like a thin film, the water was air-dried after an hour. This was exposed on the floor of a bathroom for a month. Metallic soap adhered to the island-shaped projections, and the hydrophilic property was impaired. The contact angle with respect to water became around 60 degrees. When water was fed to the tile again in the same manner as at the time of being new, the water collected in the grooves, and waterdrops on the surface were gradually absorbed into the water in the grooves. Finally, no water was left on the island-shaped projections. Also, the surface was air-dried for eight hours, and it was confirmed that the entire surface was almost dried up.

### EXAMPLE 1-3

A porcelain tile on which a glaze was applied and having a size of 300 mm×300 mm was produced, in which each unit had a square shape of 20 mm×20 mm, and grooves having a V shape, a width of 2 mm and a depth of 1 mm were formed. As the method for producing thereof, pressure forming was employed. Specifically, a plate-like product was formed by applying pressure, grooves were dug by irradiating with laser light having an intensity of ¼ for cutting a tile, and the surface was cleaned. A glaze was applied thereto, and it was fired at a temperature of 1280° C. for 60 minutes. A silicone-based water-repellent (PORON C) was applied only to the island-shaped projections by applying a plate roller to the tile. The tile was arranged on a floor at a tilt angle of around 5 degrees, and water was fed to the surface of the tile. Since the island-shaped projections were water-repellent, the contact angle with respect to water turned 100 degrees. The water rolled on the water-repellent, and flowed to gather in the grooves. No water remained on the island-shaped projections. This was exposed on the floor of a bathroom for a month. Metallic soap adhered to the island-shaped projections, and the hydrophilic property was impaired. The contact angle with respect to water became around 70 degrees. When water was fed to the tile again in the same manner as at the time of being new, the water collected in the grooves, and waterdrops on the surface were gradually absorbed into the water in the grooves. Finally, no water was left on the island-shaped projections. Also, the surface was air-dried for eight hours, and it was confirmed that the entire surface was almost dried up.

### EXAMPLE 2-1

An FRP resin having a size of 300 mm×300 mm was produced, in which each unit had a square shape of 10 mm×5 mm, and grooves having a V shape, a width of 1.5 mm and a depth of 0.5 mm were formed. The grooves were produced by injection molding in which a mold having grooves was used. The FRP resin was heated to about 60° C., and a mixed aqueous solution containing alkali silicate (manufactured by Nippon Kagaku Co. Ltd; Lithium Silicate 35) of 0.2%, titanium oxide sol of 0.1% and silver nitrate of 0.001% was applied onto the surface and the grooves by spraying. An inorganic thin film was provided on the FRP resin by drying at 60° C. for 2 minutes. The FRP resin was arranged on a floor at a tilt angle of around 3 degrees, and water was fed to the surface. The water dispersed on the surface, and flowed along the grooves. Although some water remained on the island-shaped projections like a thin film, the water was air-dried after an hour. This was exposed on the floor of a bathroom for two months. Metallic soap adhered to the island-shaped projections, and the hydrophilic property was impaired. The contact angle with respect to water became around 50 degrees. When water was fed to the surface again in the same manner as at the time of being new, the water collected in the grooves, and waterdrops on the surface were gradually absorbed into the water in the grooves. Finally, no water was left on the island-shaped projections. Also, the surface was air-dried for two hours, and it was confirmed that the entire surface was almost dried up. In addition, when the surface was cleaned lightly, and thereafter water was fed again, dirt such as the metallic soap was removed, and the surface was air-dried after about one hour. Neither mold nor slime was observed due to the effects of titanium oxide and silver ions.

### EXAMPLE 2-2

An FRP resin having a size of 300 mm×300 mm was produced, in which each unit had a square shape of 10 mm×5 mm, and grooves having a V shape, a width of 1.5 mm and a depth of 0.5 mm were formed. The grooves were produced by injection molding in which a mold having grooves was used. The FRP resin was heated to about 60° C., and a mixed aqueous solution containing alkali silicate (manufactured by Nippon Kagaku Co. Ltd; Lithium Silicate 35) of 0.2%, titanium oxide sol of 0.1% and silver nitrate of 0.001% was applied onto the surface and the grooves by spraying. An inorganic thin film was provided on the FRP resin by drying at 60° C. for 2 minutes. A silicone-based water-repellent was applied only to the island-shaped projections by a roller. Next, drying was conducted, and finally a floor material was obtained. The floor material was arranged on a floor at a tilt angle of around 3 degrees, and water was fed to the surface. The water rolled on the surface, and gathered in the grooves. No water remained on the island-shaped projections. This was exposed on the floor of a bathroom for two months. Metallic soap adhered to the island-shaped projections, and the hydrophilic property was slightly impaired. The contact angle with respect to water became around 80 degrees. When water was fed to the surface again in the same manner as at the time of being new, the water collected in the grooves, and waterdrops on the surface were gradually absorbed into the water in the grooves. Finally, no water was left on the island-shaped projections. Also, the surface was air-dried for two hours, and it was confirmed that the entire surface was almost dried up. In addition, when the surface was cleaned lightly, and thereafter water was fed again, dirt such as the metallic soap was removed, and the surface was air-dried after about one hour. Neither mold nor slime was observed due to the effects of titanium oxide and silver ions.

### EXAMPLE 3

An acrylic resin containing silica at a ratio of 50% and having a size of 300 mm×300 mm was produced, in which each unit had a square shape of 10 mm×5 mm, and grooves having a V shape, a width of 1.5 mm and a depth of 0.5 mm were formed. This was arranged on a floor at a tilt angle of around 10 degrees, and water was fed to the surface. The water dispersed on the surface, and flowed along the grooves. Although some water remained on the island-shaped projections in a state of waterdrops, it was gradually lead into the grooves, and air-dried after two hours. This was exposed on the floor of a bathroom for a month. Metallic soap adhered to the island-shaped projections, and the hydrophilic property was impaired. The contact angle with respect to water became around 65 degrees. When water was fed to the surface in the same manner as at the time of being new, the water collected in the grooves, and waterdrops on the surface were gradually absorbed into the water in the grooves. Finally, no water was left on the island-shaped projections. Also, the surface was air-dried for two hours, and it was confirmed that the entire surface was almost dried up. In addition, when the surface was cleaned lightly, and thereafter water was fed again, dirt such as the metallic soap was removed, and the surface was air-dried after about one hour.

### EXAMPLE 4

An FRP resin having a size of 300 mm×300 mm was produced, in which each unit had a square shape of 10 mm×5 mm, and grooves having a V shape, a width of 1.5 mm and a depth of 0.5 mm were formed. A mixed aqueous solution containing alkali silicate (manufactured by Nippon Kagaku Co. Ltd; Lithium Silicate 35) of 0.2%, titanium oxide sol of 0.1% and silver nitrate of 0.001% was applied by a flow coat method. The coating solution was wiped from the island-shaped projections so as to allow the coating solution to remain only in the grooves. An inorganic thin film was provided in the grooves by drying at 60° C. for 5 minutes. The FRP resin was arranged on a floor at a tilt angle of around 3 degrees, and water was fed to the surface. The water was repelled by the FRP, and flowed along the grooves. Almost no water remained on the island-shaped projections. This was exposed on the floor of a bathroom for two months. Metallic soap adhered to the island-shaped projections, and the hydrophilic property was not observed. When water was fed to the surface, waterdrops on the surface were quickly absorbed in the grooves, and no waterdrops were left on the island-shaped projections. Also, the surface was air-dried for two hours, and it was observed that the entire surface was almost dried up.

### EXAMPLE 5

A porcelain tile on which no glaze was applied and having a surface with an incline in which the central portion was high and the peripheral potion was low (150 mm×150 mm) was produced, in which each unit had a square shape of 5 mm×5 mm, and grooves having a U shape, a width of 2 mm and a depth of 1 mm were formed. The tile was arranged on a floor having no tilt angle, and water was fed to the surface of the tile. The water dispersed on the surface along the grooves. Although some water remained on the island-shaped projections like a thin film, the water was air-dried after four hours.

### EXAMPLE 6

A porcelain tile on which no glaze was applied and having a surface with an incline in which the central portion was high and the peripheral potion was low (150 mm×150 mm) was produced, in which each unit had a square shape of 5 mm×5 mm, and grooves having a U shape, a width of 2 mm and a depth of 1 mm were formed. Chamfering (providing a gradient different from the incline of the tile body) was conducted to the edge portion of the tile. The tile was arranged on a floor having no tilt angle, and water was fed to the surface of the tile. The water dispersed on the surface along the grooves. Although some water remained on the island-shaped projections like a thin film, the water was air-dried after 2.5 hours.

### EXAMPLE 7

A porcelain tile on which no glaze was applied and having a surface with an incline in which the central portion was high and the peripheral potion was low (150 mm×150 mm) was produced, in which each unit had a square shape of 5 mm×5 mm, and grooves having a U shape, a width of 2 mm and a depth of 1 mm were formed. Chamfering (providing a gradient different from the incline of the tile body) was conducted to the edge portion of the tile in two stages. The tile was arranged on a floor having no tilt angle, and water was fed to the surface of the tile. The water dispersed on the surface along the grooves. Although some water remained on the island-shaped projections like a thin film, the water was air-dried after two hours.

Industrial Applicability

According to the present invention, it is possible to provide a building material in which water remaining on the surface can be dried up quickly and keep a hygienic state for a long period of time.

1. A building material comprising:
grooves having a width of 0.5 mm or more and 3.0 mm or less and a depth of 0.5 mm or more and 2.0 mm or less, and
island-shaped projections for preventing slippage constructed of a unit having a size of 5 mm×5 mm or more and 25 mm×25 mm or less, the island-shaped projections being surrounded by the grooves,
wherein the surface of the building material on which the grooves and the island-shaped projections for preventing slippage are provided has a shape with an incline in which the central portion is high and the peripheral potion is low such as a dome shape, a bell shape, or a combination of shapes, and
wherein the grooves are arranged in a multiple direction, so that water on the island-shaped projections smoothly flows from the grooves into the joint between the building materials.

2. (Canceled)

3. The building material according to claim 1, wherein the grooves substantially have no water-absorbing property.

4. The building material according to claim 1, wherein the grooves include an anti-bacterial agent.

5. The building material according to claim 1, wherein the size of the building material which includes the units is 100 mm×100 mm or more and 900 mm×1800 mm or less.

6. The building material according to claim 1, wherein the shape of the grooves is one in which the area of the upper portion is greater than that of the lower potion.

7. The building material according to claim 1, wherein the building material is an inorganic ceramic material such as tile, a pottery plate or glass, an organic material whose surface is coated with an inorganic material, or an organic-inorganic composite material including an inorganic filler, which is comprised of an oxide or a composite oxide, at a ratio of 50% or more.

8. The building material according to claim 7, wherein the inorganic material with which the surface is coated is SiO₂, Al₂O₃, ZrO₂, Fe₂O₃, CaO, MgO, K₂O, Na₂O, a material having a photocatalytic function such as TiO₂, ZnO, SnO₂ or the like, a material having an anti-bacterial property such as Ag, Cu or the like, or a composite material thereof.

9. The building material according to claim 7, wherein the inorganic filler is SiO₂, Al₂O₃, ZrO₂, Fe₂O₃, CaO, MgO, K₂O, Na₂O, a material having a photocatalytic function such as TiO₂, ZnO, SnO₂ or the like, a material having an anti-bacterial property such as Ag, Cu or the like, or a composite material thereof.

10. The building material according to claim 1, wherein the grooves and the projections are manufactured by pressure forming.

11. The building material according to claim 10, wherein a die having projections on a surface thereof so as to form grooves in a formed product is used for pressure forming.

12. The building material according to claim 1, wherein the grooves and the projections are manufactured by digging the grooves in a predetermined pattern after a flat plate is formed by pressure forming.

13. The building material according to claim 12, wherein the grooves are manufactured with a grindstone, laser light, or sandblasting.

14. The building material according to claim 1, wherein the grooves and the projections are manufactured by pushing a concavo-convex die having a pattern on the surface thereof onto a flat plate which is formed by extrusion.

15. The building material according to claim 1, wherein the grooves and the projections are manufactured by injection molding using a mold having a groove pattern.

16. The building material according to claim 10, wherein the projections of the building material are coated with a water-repellent material.

17. The building material according to claim 3, wherein the grooves include an anti-bacterial agent.

18. The building material according to claim 3, wherein the size of the building material which includes the units is 100 mm×100 mm or more and 900 mm×1800 mm or less.

19. The building material according to claim 3, wherein the shape of the grooves is one in which the area of the upper portion is greater than that of the lower potion.

20. The building material according to claim 3, wherein the building material is an inorganic ceramic material such as tile, a pottery plate or glass, an organic material whose surface is coated with an inorganic material, or an organic-inorganic composite material including an inorganic filler, which is comprised of an oxide or a composite oxide, at a ratio of 50% or more.
